(19) United States
(12) Patent Application Publication
(10) Pub. No.: US 2026/0332038 A1
(43) Pub. Date: Oct. 22, 2026

(54) POWER CONVERSION DEVICE

(71) Applicant: LG INNOTEK CO., LTD., Seoul (KR)

(72) Inventors: Kwan Soo LEE, Seoul (KR); Se Jin LIM, Seoul (KR)

(21) Appl. No.: 19/105,885

(22) PCT Filed: Aug. 25, 2023
(86) PCT No.: PCT/KR2023/012677

§ 371 Date: Feb. 24, 2025

(30) Foreign Application Priority Data
Aug. 25, 2022 (KR) 10-2022-0107184

(51) Int. Cl. H02M 1/32; H02J 3/38; H02J 101/24; H02M 1/00; H02M 7/537; H02S 40/32

(52) U.S. Cl. CPC H02M 1/322; H02J 3/38; H02M 1/0032; H02M 7/537; H02S 40/32; H02J 2101/24

(57) ABSTRACT

A power conversion device according to one embodiment of the present invention comprises: an input unit for receiving voltage generated in a photovoltaic power generation panel; a power conversion unit for converting input voltage that is input into the input unit; an output unit for outputting the converted voltage to a system or a load; and a voltage-discharging unit connected to the input unit so as to discharge the input voltage.

### TECHNICAL FIELD

The present invention relates to a power conversion device, and more specifically, to a power conversion device and a photovoltaic power generation system capable of rapidly lowering the voltage when an abnormal voltage occurs.

### BACKGROUND ART

Photovoltaic power generation is an eco-friendly energy generation method that is widely used as a replacement for existing chemical power generation or nuclear power generation. Photovoltaic power generation can be either a standalone type where a battery is connected to a converter or a connected type where it is connected to a power grid. Standalone power generation is generally composed of solar cells, storage batteries, and power conversion devices, while a power grid-connected system is configured to be connected to a commercial power source so that power can be exchanged with the load grid line.

In the case of a fire or other abnormality in a photovoltaic power generation panel, the voltage must be lowered below a certain level within a short period of time to protect workers from electric shock and other causes in subsequent processing, thereby requiring a technology that can detect the abnormal voltage and safely lower the voltage.

### DETAILED DESCRIPTION OF THE INVENTION

### Technical Subject

The technical problem to be solved by the present invention is to provide a power conversion device and a photovoltaic power generation system capable of rapidly lowering the voltage when an abnormal voltage occurs.

### Technical Solution

A power conversion device according to one embodiment of the present invention comprises: an input unit for receiving voltage generated in a photovoltaic power generation panel; a power conversion unit for converting input voltage that is input into the input unit; an output unit for outputting the converted voltage to a system or a load; and a voltage-discharging unit connected to the input unit so as to discharge the input voltage.

In addition, the input unit is connected to an MLPE that optimizes the voltage of the photovoltaic power generation panel so as to receive the input voltage.

In addition, the input voltage is a first DC voltage, wherein the power conversion unit may include: a DC-DC converter unit that converts the first DC voltage into a second DC voltage; and an inverter unit that converts the second DC voltage into a first AC voltage.

In addition, it may include a control unit that operates the voltage-discharging unit according to the state of the input voltage.

In addition, the control unit monitors the input voltage and can turn off the operation of the power conversion unit and operate the voltage-discharging unit when the input voltage is lower than a first voltage.

In addition, the voltage-discharging unit may include: a switching unit that is turned on when the input voltage is lower than a first voltage; and a resistance element that discharges the input voltage to be lower than a second voltage according to the operation of the switching unit.

In addition, the voltage-discharging unit may include an RSD performing unit that performs rapid shut down (RSD) on the input voltage.

In order to solve the above technical problem, a photovoltaic power generation system according to one embodiment of the present invention comprises: at least one photovoltaic power generation panel; and a power conversion module that converts voltage generated by the photovoltaic power generation panel and outputs it to a grid or a load, wherein the power conversion module includes: an input unit which receives voltage generated by the photovoltaic power generation panel; a power conversion unit that converts input voltage inputted to the input unit; an output unit that outputs the converted voltage to a grid or a load; and a voltage-discharging unit connected to the input unit so as to discharge the input voltage.

In addition, it includes an MLPE that optimizes the voltage of the photovoltaic power generation panel, wherein the input unit connected to the MLPE so as to receive the input voltage.

In addition, the power conversion module may include a control unit that operates the voltage-discharging unit according to the state of the input voltage.

In addition, the control unit can monitor the input voltage, and turn off the operation of the power conversion unit and operate the voltage discharge unit when the input voltage is lower than a first voltage.

### Advantageous Effects

According to embodiments of the present invention, the inverter itself monitors and performs RSD operation without adding a module configured as a separate accessory for RSD operation or interworking with the MLPE, thereby enabling interworking with PV array and MLPE, thereby facilitating system compatibility and PVRSS certification. In addition, since the RSD function is performed in the inverter, there is no need to separately perform functional safety in the MLPE, thereby reducing the time, manpower, and cost required for performing functional safety. Furthermore, since separate communication is not required for the RSD operation, a component CI effect occurs, and system compatibility is good with not only PV array without PLC communication but also MLPE not being applied with Sunspec, and it is possible to respond to system compatibility certification.

### BRIEF DESCRIPTION OF DRAWINGS

FIG. 1 is a block diagram of a power conversion device according to an embodiment of the present invention.

FIG. 2 is a block diagram of a power conversion device according to an embodiment of the present invention.

FIG. 3 is a block diagram of a power conversion device according to a comparative example of the present invention.

FIG. 4 and FIG. 5 are block diagrams of a power conversion device according to an embodiment of the present invention.

FIG. 6 illustrates an application example of a voltage-discharging circuit according to an embodiment of the present invention.

FIG. 7 is a diagram for explaining voltage-discharging according to an embodiment of the present invention.

FIG. 8 is a block diagram of a photovoltaic power generation system according to an embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and within the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention. In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used.

These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction based on one component may be included.

A modified embodiment according to the present embodiment may include some components of each embodiment and some components of other embodiments. That is, a modified embodiment may include one embodiment of various embodiments, but may omit some components and include some components of the corresponding other embodiment. Or, it may be the opposite. The features, structures, effects, and the like to be described in the embodiments are included in at least one embodiment, and are not necessarily limited to one embodiment. Furthermore, the features, structures, effects, and the like exemplified in each embodiment may be combined or modified and implemented in other embodiments by a person having ordinary skill in the field to which the embodiments belong. Therefore, the contents related to such combinations and modifications should be interpreted as being included in the scope of the embodiment.

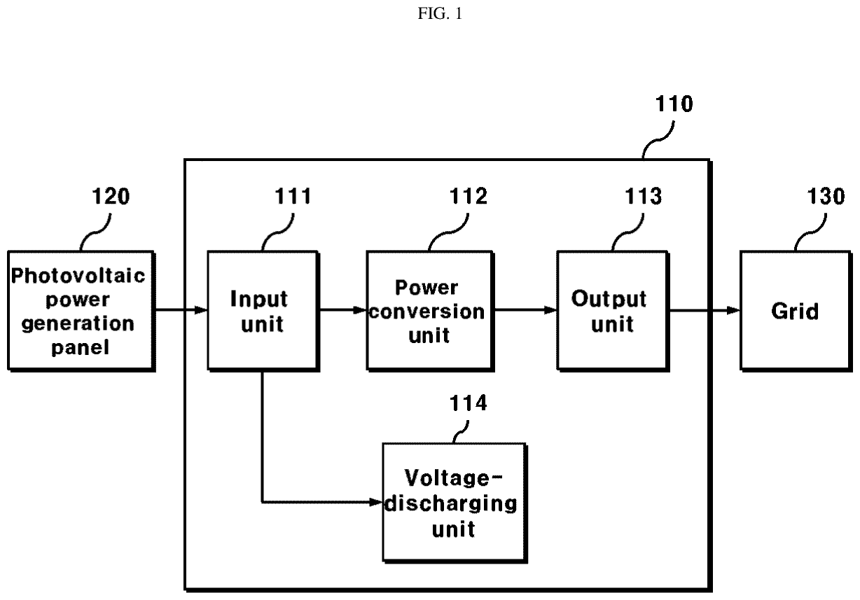

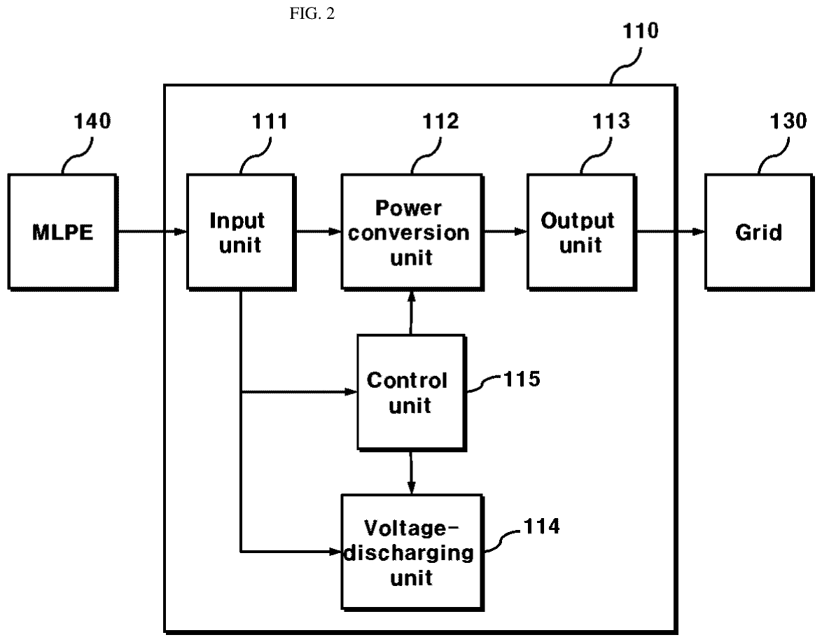

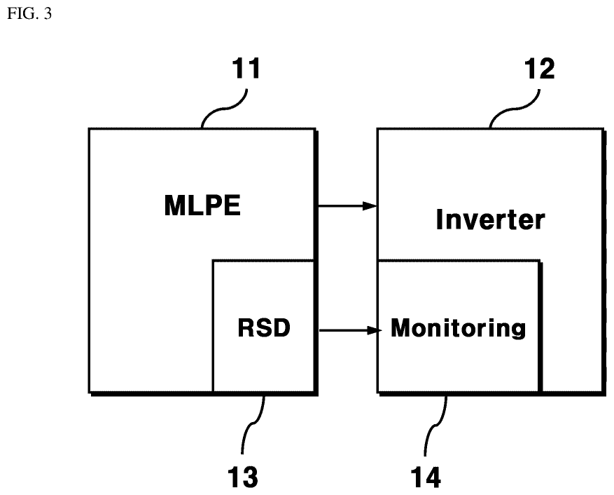

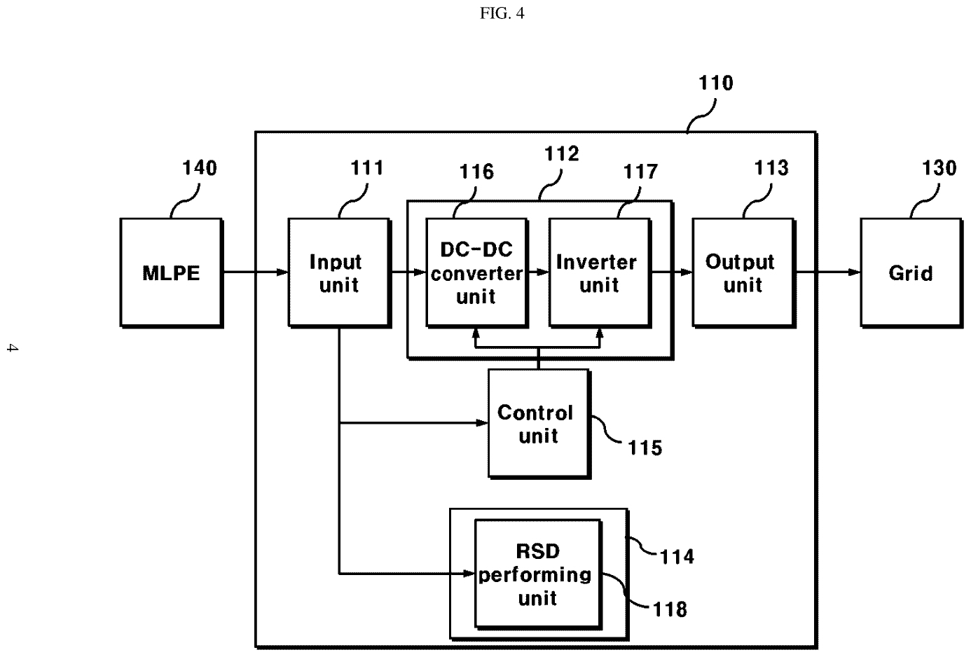

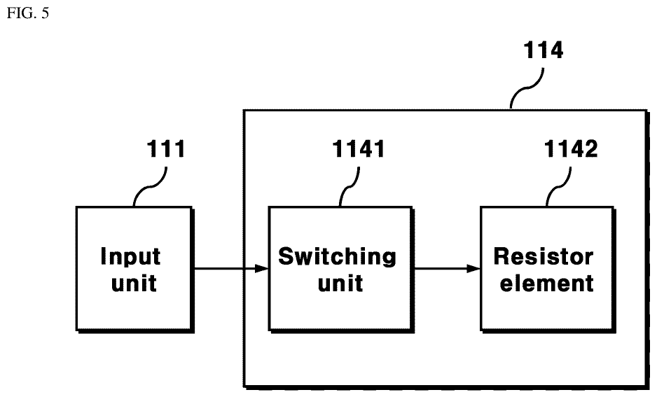

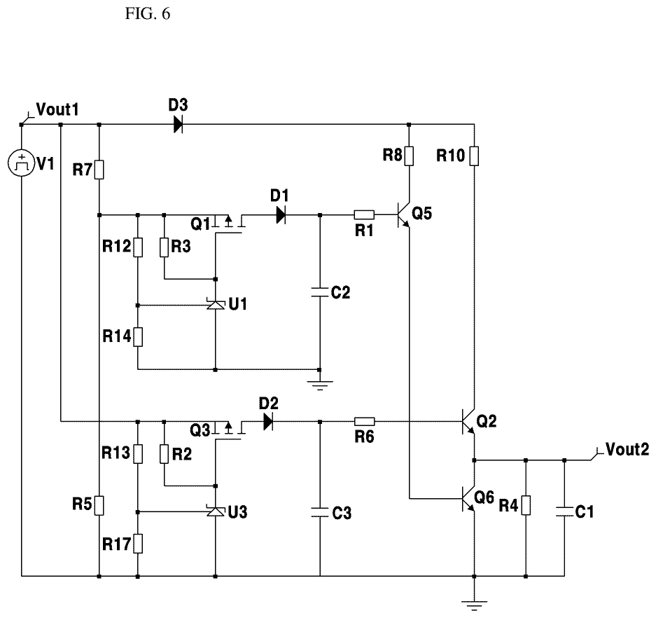

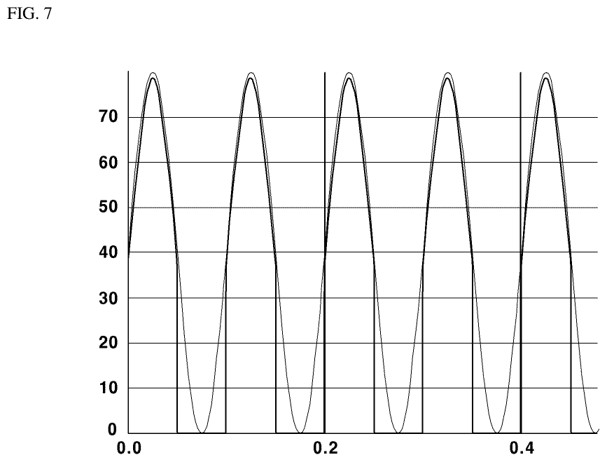

FIG. 1 is a block diagram of a power conversion device according to an embodiment of the present invention; FIG. 2 is a block diagram of a power conversion device according to an embodiment of the present invention; FIG. 3 is a block diagram of a power conversion device according to a comparative example of the present invention; FIG. 4 and FIG. 5 are block diagrams of a power conversion device according to an embodiment of the present invention; FIG. 6 illustrates an application example of a voltage-discharging circuit according to an embodiment of the present invention; and FIG. 7 is a diagram for explaining voltage-discharging according to an embodiment of the present invention.

A power conversion device 110 according to one embodiment of the present invention is composed of an input unit 111, a power conversion unit 112, a voltage discharge unit 114, and may include an output unit 113 and a control unit 115.

A power conversion device 110 according to the embodiment of the present invention may be an inverter. In a photovoltaic power generation system, it may be an inverter that receives voltage from a photovoltaic power generation panel 120 or an MLPE 140 and converts the voltage required for a grid 130 or a load (not shown).

The input unit 111 receives the voltage generated by the photovoltaic power generation panel 120 or is connected to the MLPE 140 that optimizes the voltage of the photovoltaic power generation panel and receives the voltage from the MLPE 140. The solar cell module of the photovoltaic power generation panel 120 has a different maximum power point depending on the amount of sunlight, temperature, and the like. In order to operate the solar cell at the maximum power point, the module-level power electronics (MLPE) that performs maximum power point tracking (MPPT) control in units of modules may be used. The power converter being connected to the photovoltaic power generation panel 120 on which the MLPE 140 is mounted receives a voltage through the MLPE 140.

The power conversion unit 112 converts the input voltage inputted to the input unit 111. It converts the input voltage into a voltage required by the grid 130 or the load. The power conversion unit 112 may be an inverter. The power conversion unit 112 may convert the input voltage, which is a first direct current voltage, into a first alternating current voltage. The first alternating current voltage may be a rated voltage of the grid 130 or a voltage suitable for the load. Here, the load may be a device driven by using a voltage being generated by a photovoltaic power generation panel. For example, it may be a building in which a photovoltaic power generation panel is installed, or a device in a home.

The power conversion unit 112 may include a DC-DC converter unit 116 and an inverter unit 117. The DC-DC converter unit 116 may convert a first DC voltage into a second DC voltage. Here, an input voltage being inputted to the input unit 111 is a first DC voltage, and the DC-DC converter unit may convert the first DC voltage into a second DC voltage. The first DC voltage may vary depending on the power generation level of the photovoltaic power generation panel 120 or depending on the maximum power point tracking of the MLPE 140. The second DC voltage may be a rated voltage of the grid 130 or a voltage suitable for a load. Here, the load may be a battery, and the second DC voltage may be a rated voltage of the battery.

The inverter unit 117 can convert the second DC voltage into a first AC voltage. The inverter unit 117 can convert the second DC voltage, whose voltage level is converted by the DC-DC converter unit, into a first AC voltage according to the voltage form of the grid 130 so that it can be output to the grid 130. Since the grid 130 uses an AC voltage, the DC voltage must be changed into an AC voltage and outputted.

When a battery is connected between the DC-DC converter unit 116 and the inverter unit 117, not only is there a path for outputting the voltage generated in the DC-DC converter unit 116 directly to the grid 130 through the inverter unit 117, but the battery can also be charged with the voltage generated in the DC-DC converter unit 116, and when necessary, the voltage of the battery can be converted by the inverter unit 117 and outputted to the grid 130. Through this, efficient power supply becomes possible.

The output unit 113 can output the voltage converted by the power conversion unit 112 to the grid 130 or a load. The output unit 113 includes a switching unit and is connected to either the grid 130 or a load to output the voltage converted by the power conversion unit 112.

The voltage-discharging unit 114 is connected to the input unit 111 and discharges the input voltage. The voltage-discharging unit 114 does not operate when a normal range of input voltage is inputted to the input unit 111, and operates when an abnormal range of input voltage is inputted to the input unit 111 to quickly discharge the input voltage. The voltage-discharging unit 114 monitors the input voltage being inputted to the input unit 111, and can discharge the input voltage when the input voltage range is abnormal.

When a fire or other abnormality occurs in the photovoltaic power generation panel 120, the voltage level of the input voltage is lowered, and as a result, when an abnormal range of input voltage is inputted, the voltage-discharging unit 114 operates to quickly discharge the voltage of the photovoltaic power generation panel 120. When a fire occurs, workers such as firefighters may approach the photovoltaic power generation panel, but there may be a risk of electric shock because the residual voltage is high. The voltage-discharging unit 114 can quickly lower the residual voltage of the photovoltaic power generation panel 120 to eliminate the risk of electric shock.

The voltage-discharging unit 114 may include a switching unit 1141 that is turned on when the input voltage is lower than the first voltage, and a resistance element 1142 that discharges the input voltage to a second voltage or lower according to the operation of the switching unit. When the input voltage is within a normal range, that is, higher than the first voltage, the voltage-discharging unit 114 does not operate, and when the input voltage becomes lower than the first voltage, the switching unit 1141 is turned on to connect the resistance element 1142 to the input unit 111, and through the resistance element 1142, the input voltage of the input unit 111 is quickly discharged to a second voltage or lower, thereby lowering the voltage of the photovoltaic power generation panel 120 connected to the input unit 111 to a safe range. When the input voltage becomes lower than the second voltage, the operation of the voltage-discharging unit 114 may be turned off, and the input voltage may be monitored.

For example, the first voltage may be 35 V, and the second voltage may be 30 V. When the photovoltaic power generation panel 120 operates normally, the input voltage may be 80 V, and when the input voltage drops from 80 V to 35 V or less due to a fire or the like, the switching unit 1141 is turned on so that the resistance element 1142 is connected to the input unit 111, and the voltage of the input unit 111 can be quickly lowered to 30 V or less. At this time, the voltage of the input unit 111 can be lowered to 30 V or less within 10 or 30 seconds. The switching unit 1141 may include one or more FETs or MOSFETs, and may include various switching elements such as a BJT. The resistance element 1142 may include one or more resistors. Depending on the discharge speed of the resistance element 1142, it is determined whether discharge below the second voltage is possible within the first time, and the resistance value of the resistance element 1142 may vary depending on the required safety specifications.

The voltage-discharging unit 114 may include an RSD performing unit 118 that performs rapid shut down (RSD) on the input voltage. The rapid shut down (RSD) is a safety function that can rapidly lower the voltage when an abnormality occurs. During normal operation, The RSD operates in standby or sleep mode, and when an abnormality occurs, it operates in operating or wake-up mode to rapidly lower the voltage.

The control unit 115 can operate the voltage-discharging unit 114 according to the state of the input voltage. The control unit 115 can be a micro controller unit (MCU) of the power conversion device 110. The control unit 115 can monitor the input voltage input to the input unit 111 and control the power conversion unit to convert the input voltage into a voltage suitable for the grid 130 or a load. Here, the power conversion unit 112 can include at least one switching element, and the control unit 115 can control the on/off duty of the switching element to convert the input voltage. The control unit 115 can control the DC-DC converter unit 116 and the inverter unit 117 of FIG. 4. When an input voltage within a normal range is input, the DC-DC converter unit 116 and the inverter unit 117 can be controlled to convert the first DC voltage into a second DC voltage and the second DC voltage into a first AC voltage.

The control unit 115 monitors the input voltage, and if the input voltage is lower than the first voltage, turns off the operation of the power conversion unit 112 and operates the voltage-discharging unit 114. If an input voltage in an abnormal range lower than the first voltage is input, the control unit 115 turns off the operation of the power conversion unit 112 to protect the power conversion device 110 and the grid 130, and operates the voltage-discharging unit 114 to protect the photovoltaic power generation panel 120 or the MLPE 140. The control unit 115 turns on the switching unit 1141 of the voltage-discharging unit 114 to connect the input unit 111 and the resistance element 1142 to discharge the input voltage.

The control unit 115 can turn off the operation of the voltage-discharging unit 114 and monitor the input voltage when the input voltage becomes higher than the first voltage again. At this time, the control unit 115 can operate the power conversion unit 112.

Since the control unit 115 and the voltage-discharging unit 114 are built into a single power conversion device 110, the monitoring information on the input voltage being inputted to the input unit 111 can be directly shared, and voltage discharge can be performed even if communication with the outside is cut off, thereby ensuring stability. In addition, the inverter itself monitors and performs RSD operation without adding a module configured with a separate accessory for RSD operation or interworking with the MLPE, so that it can be interlocked with PV array and MLPE, making system compatibility and PVRSS certification easy, and since the RSD function is performed in the inverter, there is no need to perform functional safety separately in the MLPE, and accordingly, the time, manpower, and cost required for performing functional safety can be reduced. Furthermore, since separate communication is not required for RSD operation, the component CI effect occurs, and the system compatibility is good with not only PV array without PLC communication but also MLPE not being applied with Sunspec, and it is possible to respond to system compatibility certification.

In the comparative example of FIG. 3, where the RSD module that discharges the voltage is formed in the MLPE instead of the inverter, the inverter 12 receives the voltage from the MLPE 11 and monitors the RSD situation 14 by monitoring the voltage being inputted. Since the RSD module 13 is formed in the MLPE 11 instead of the inverter 12, additional accessory installation is required for each MLPE 11. In addition, when an RSD situation occurs, in order to transmit the RSD situation to the RSD module 13, the RSD situation must be transmitted through PLC communication using the input power line of the inverter 12; in this case, there may be a problem that it is vulnerable to such as PLC noise, and if a separate communication is used, it may incur a high cost. In addition, since the MLPE 11 and the inverter 12 are interconnected to perform the RSD operation, there may be limitations in compatibility with other products, and UL certification may be required through the PVRSS compatibility test that verifies compatibility. In addition, when performing RSD in MLPE, there may be issues with development period, manpower, and cost due to functional safety performance.

However, the power conversion device 110 according to the embodiment of the present invention performs RSD situation monitoring and RSD operation within a single device, so that it can quickly process RSD situation response without communication noise or installation of additional accessories.

The voltage-discharging unit 114 can be implemented with a circuit as shown in FIG. 6. The voltage-discharging unit 114 can include a plurality of resistors, switching elements, and capacitors as shown in FIG. 6. The input terminal includes a MOSFET Q1 connected to the input terminal via a resistor R7, the source of Q1 is connected to a node connecting R7 and R5, and R12 and R3 can be connected in parallel to the node. R12 and R14 are connected, and the node between R12 and R14 can be connected to the gate of Q1 via a Zener diode U1. R3 is connected between the source and the gate of Q1, and a diode D1 can be connected to the drain of Q1. D1 connects the drain of Q1 and R1, and R1 can be connected to D1 and the base of BJT Q5. The collector of Q5 is connected to R8. A capacitor C2 can be connected to the node between D1 and R1. R14, U1, C2 can be connected to ground at one end. Diode D3 is connected in parallel with R7 at the input terminal, and D3 can be connected to R8.

The input terminal can be connected to the MOSFET Q3 being connected in parallel with R7. R13 and R2 are connected in parallel to the node between the input terminal and Q3, R13 and R17 are connected, and the node between R13 and R17 can be connected to the gate of Q3 via the Zener diode U3. R2 can be connected between the source and the gate of Q3, and a diode D2 can be connected to the drain of Q1. D2 connects the drain of Q3 and R6, and R6 can be connected to D2 and the base of BJT Q2. The collector of Q2 is connected to R10, and R10 can be connected between Q2 and D3. A capacitor C3 can be connected to the node between D2 and R6. One end of R17, U3, and C3 can be connected to ground. The emitter of Q2 can be connected to the collector of Q6, and the collector of Q5 can be connected to the base of Q6. R4 and capacitor C1 can be connected in parallel at the node between Q2 and Q6. Depending on the input voltage, Q1 to Q6 can be turned on, and the input voltage of the input unit can be quickly discharged by R1 to R17 and C1 to C3.

The control unit 115 can turn on Q1 or Q3 by applying a gate voltage to the gate. The control unit 115 monitors the input voltage, and when the input voltage falls within an abnormal voltage range, turns on Q1 or Q3 to quickly discharge the input voltage.

As described above, by operating the voltage-discharging unit 114 built into the power conversion device 110, the voltage can be quickly lowered when an abnormality occurs. FIG. 7 shows the output voltage of the MLPE 140 and the output voltage of the DC-DC converter unit 116 according to an embodiment of the present invention. When the output voltage of the MLPE 140, which is the input voltage of the power conversion device 110, is equal to or higher than the first voltage of 35 V, it can be confirmed that the device operates normally, and when the output voltage of the MLPE 140 becomes lower than 35 V, the voltage is lowered to 0 V due to the discharge of the voltage-discharging unit 114. Thereafter, when it becomes higher than 35 V again, it can be confirmed that the device operates normally.

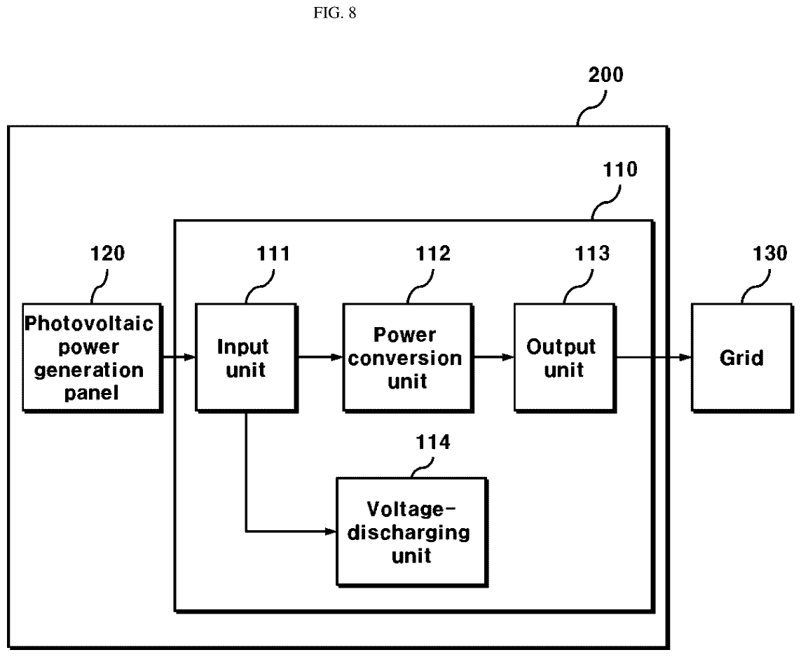

FIG. 8 is a block diagram of a photovoltaic power generation system 200 according to one embodiment of the present invention. A detailed description of each component of the photovoltaic power generation system 200 of FIG. 8 corresponds to the detailed description of the power conversion device of FIGS. 1 to 7, and thus, any duplicate description will be omitted below.

A photovoltaic power generation system 200 according to an embodiment of the present invention includes at least one photovoltaic power generation panel 120 and a power conversion module 110 that converts voltage generated by the photovoltaic power generation panel 120 and outputs it to a grid 130 or a load. The power conversion module 110 may include: an input unit 111 that receives voltage generated by the photovoltaic power generation panel 120; a power conversion unit 112 that converts input voltage input to the input unit 111; an output unit 113 that outputs the converted voltage to a grid 130 or a load; and a voltage-discharging unit 114 being connected to the input unit 111 and discharging the input voltage.

The photovoltaic power generation panel 120 may include an MLPE 140 that optimizes the voltage, the input unit 111 may be connected to the MLPE 140 to receive the input voltage, and the power conversion module 110 may include a control unit 115 that operates the voltage-discharging unit 114 according to the state of the input voltage.

The control unit 115 monitors the input voltage, and if the input voltage is lower than the first voltage, turns off the operation of the power conversion unit 112 and operates the voltage-discharging unit 114.

The features, structures, effects, etc. described in the embodiments above are included in at least one embodiment, and are not necessarily limited to one embodiment. Furthermore, the features, structures, effects, and the like exemplified in each embodiment can be combined or modified and implemented in other embodiments by a person having ordinary knowledge in the field to which the embodiments belong. Therefore, the contents related to such combinations and modifications should be interpreted as being included in the scope of the embodiments.

Those skilled in the art related to the present embodiment will understand that the above-described description can be implemented in a modified form without departing from the essential characteristics thereof. Therefore, the disclosed methods should be considered from an illustrative rather than a restrictive perspective. The scope of the present invention is indicated by the claims, not the above description, and all differences within the scope equivalent thereto should be interpreted as being included in the present invention.

1. A power conversion device comprising:
an input unit receiving voltage generated from a photovoltaic power generation panel;
a power conversion unit configured to convert input voltage input to the input unit;
an output unit outputting the converted voltage to a grid or load; and
a voltage-discharging unit connected to the input unit and configured to discharge the input voltage.

2. The power conversion device according to claim 1,
wherein the input unit is connected to the MLPE, which optimizes voltage of the photovoltaic power generation panel, and receives the input voltage.

3. The power conversion device according to claim 1,
wherein the input voltage is a first DC voltage, and
wherein the power conversion unit comprises:
a DC-DC converter unit configured to convert the first DC voltage into a second DC voltage; and
an inverter unit configured to convert the second DC voltage into a first AC voltage.

4. The power conversion device according to claim 1, comprising:
a control unit configured to operate the voltage-discharging unit according to a state of the input voltage.

5. The power conversion device according to claim 4,
wherein the control unit monitors the input voltage, and, when the input voltage is lower than a first voltage, turns off operation of the power conversion unit and operates the voltage-discharging unit.

6-10. (canceled)

11. The power conversion device according to claim 4,
wherein when the input voltage is in abnormal state, the control unit turns off operation of the power conversion unit and operates the voltage-discharging unit.

12. The power conversion device according to claim 1,
wherein the voltage-discharging unit comprises:
a switching unit configured to be turned on when the input voltage is lower than a first voltage; and
a resistance element discharging the input voltage to be lower than a second voltage according to operation of the switching unit.

13. The power conversion device according to claim 12,
wherein the switching unit comprises a MOSFET.

14. The power conversion device according to claim 1,
wherein the voltage-discharging unit comprises an RSD performing unit which performs rapid shut down (RSD) for the input voltage.

15. The power conversion device according to claim 14,
wherein the RSD performing unit operates as standby mode or sleep mode in normal state and operates as wake-up mode in abnormal state.

16. A photovoltaic power generation system, comprising:
at least one photovoltaic power generation panel; and
a power conversion module configured to convert voltage generated by the photovoltaic power generation panel and output it to a grid or a load,
wherein the power conversion module comprises:
an input unit receiving voltage generated by the photovoltaic power generation panel;
a power conversion unit configured to convert input voltage input to the input unit;
an output unit outputting the converted voltage to a grid or a load; and
a voltage-discharging unit connected to the input unit and configured to discharge the input voltage.

17. The photovoltaic power generation system according to claim 16, comprising:
an MLPE configured to optimize the voltage of the photovoltaic power generation panel,
wherein the input unit is connected to the MLPE so as to receive the input voltage.

18. The power conversion device according to claim 1,
wherein the input voltage is a first DC voltage, and
wherein the power conversion unit comprises:
a DC-DC converter unit configured to convert the first DC voltage into a second DC voltage; and
an inverter unit configured to convert the second DC voltage into a first AC voltage.

19. The photovoltaic power generation system according to claim 16,
wherein the power conversion module comprises a control unit which operates the voltage-discharging unit according to state of the input voltage.

20. The photovoltaic power generation system according to claim 19,
wherein the control unit monitors the input voltage, and, when the input voltage is lower than a first voltage, turns off operation of the power conversion unit and operates the voltage-discharging unit.

21. The photovoltaic power generation system according to claim 19,
wherein when the input voltage is in abnormal state, the control unit turns off operation of the power conversion unit and operates the voltage-discharging unit.

22. The photovoltaic power generation system according to claim 16,
wherein the voltage-discharging unit comprises:
a switching unit configured to be turned on when the input voltage is lower than a first voltage; and
a resistance element discharging the input voltage to be lower than a second voltage according to operation of the switching unit.

23. The photovoltaic power generation system according to claim 22,
wherein the switching unit comprises a MOSFET.

24. The photovoltaic power generation system according to claim 16,
wherein the voltage-discharging unit comprises an RSD performing unit which performs rapid shut down (RSD) for the input voltage.

25. The photovoltaic power generation system according to claim 24,
wherein the RSD performing unit operates as standby mode or sleep mode in normal state and operates as wake-up mode in abnormal state.
